(19) United States
(12) Patent Application Publication
(10) Pub. No.: US 2021/0399371 A1
(43) Pub. Date: Dec. 23, 2021

(54) Temporary Cap for Electrochemical cell

(71) Applicant: STOREDOT LTD, Herzeliya (IL)

(72) Inventors: Assaf ZEHAVI, Haifa (IL); Nir Dolev, Lehavim (IL); Tzemah KISLEV, Mazkeret-Bathya (IL)

(73) Assignee: STOREDOT LTD, Herzeliya (IL)

(21) Appl. No.: 17/304,648

(22) Filed: Jun. 23, 2021

Related U.S. Application Data
(60) Provisional application No. 62/705,364, filed on Jun. 23, 2020.

(51) Int. Cl. H01M 50/186; H01M 10/04; H01M 50/184

(52) U.S. Cl. CPC H01M 50/186; H01M 50/184; H01M 10/0422

(57) ABSTRACT

A method for managing gas generated during a formation phase of a cell that is a hard-case electrochemical cell, the method may include supplying electrolyte to the cell; initially charging and discharging the cell during a formation phase; and permanently sealing the cell; wherein the method further comprises temporarily sealing the electrolyte during the formation phase.

### CROSS REFERENCE

This application claims priority from U.S. provisional patent 62/705,364 filing date Jun. 23, 2020 which is incorporated herein by reference.

### BACKGROUND

A hard-cased cell typically is manufactured by a manufacturing process that includes preparing raw electrode materials, preparing a slurry from the electrode materials, coating a metallic foil with the slurry and drying coated foil, rolling the coated foil under pressure to achieve the desired porosity, punching the coated foils of the desired porosity to provide electrodes of a desired shape, assembling a cell having the electrodes with a separator between them, injecting the electrolyte, permanently sealing the case, and initially charging and the cell during a formation phase.

During the formation phase the cell produces gas. The gas quantity, generated during the formation phase, depends on various parameters such as the chemical composition of the cell, the capacity of the cell (mAh), formation phase parameters (currents profiles, voltage ranges etc.) ambient conditions (temperature, pressure), electrolyte quantity, electrodes thickness and density, and the like.

Some chemicals cannot be used in hard-cased batteries due to their high gas emission.

The permanent sealing does not allow the generated gas (during the formation) to exit the cell. If, due to the gas emitted within the cell and during the formation, the gas pressure inside the hard case is too high, the cell can be damaged. Examples of such damage may include swelling of the case, burst of the case, structural damage to the electrodes or any other part of the cell, damage to the CID (Current Interrupter Device) or any other safety feature of the cell. The CID is a fuse-type device that breaks and cuts off the electrical circuit permanently when triggered by excessive cell pressure. Once broken—gas can pass through the CID—but the CID, once broken (the process is irreversible), renders the cell inoperative. Furthermore—the pressure of a disintegrating cell can be so large that the gases are unable to escape in an orderly way and venting with flame occurs.

There is a growing need to provide a method and a cell for gas removal during the manufacturing process of hard-case batteries.

### SUMMARY

There may be provide a method and a cell for gas removal during the manufacturing process of hard-case batteries.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates an examples of a method;

FIG. 2 illustrates an example of various steps of a method;

FIG. 3 illustrates an example of various steps of a method;

FIG. 4 illustrates an example of various steps of a method;

FIG. 5 illustrates an example of various steps of a method;

FIG. 6 illustrates an example of various steps of a method;

FIG. 7 an illustrates an example of a cell, a chamber, and a temporary cap; and

FIG. 8 illustrates an example of a temporary cap.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a battery capable of executing the method and/or to a battery manufactured by the method.

Any reference in the specification to a battery should be applied mutatis mutandis to a method for operating the battery and/or to a method for manufacturing the battery.

Any combination of any module or unit listed in any of the figures, any part of the specification and/or any claims may be provided.

Any combination of any steps of any method illustrated in the specification and/or drawings may be provided.

Any combination of any subject matter of any of claims may be provided.

The formation phase may include charging the cell but may also include discharging the cell. Any reference to charging may be applied, mutatis mutandis, to a combination of charging and discharging.

The gas removal may be executed during the formation phase, after the formation phase and both during and after the formation phase. Any reference to gas discharge during the formation phase may be applied, mutatis mutandis, to gas discharged after the formation phase and may be applied, mutatis mutandis, to a combination of gas discharging during and after the formation phase.

The amount of electrolyte and/or salt, and/or solvent and/or electrolyte additive may be changed and/or the electrolyte may be changed during and/or after the formation process. In this context any reference to an electrolyte should be applied mutatis mutandis to salt and/or solvent and/or electrolyte additive. In this context any reference to a change in an amount may be applied mutatis mutandis to replacement.

The application refers to a cell that may include electrolyte that is liquid and interfaces with one or more elements of the cell. For example—the cell may include different gel or hybrid structures, for example solid state separator with liquid electrolyte on at least one electrode side. The common between the cell structures is the presence of liquid electrolyte and gas release reaction during formation or/and cycling.

There is provided a method that prevents the formation of excessive pressure (due to gas emission) inside the hard case cell during the formation phase, and allows gas removal after the formation and before final sealing.

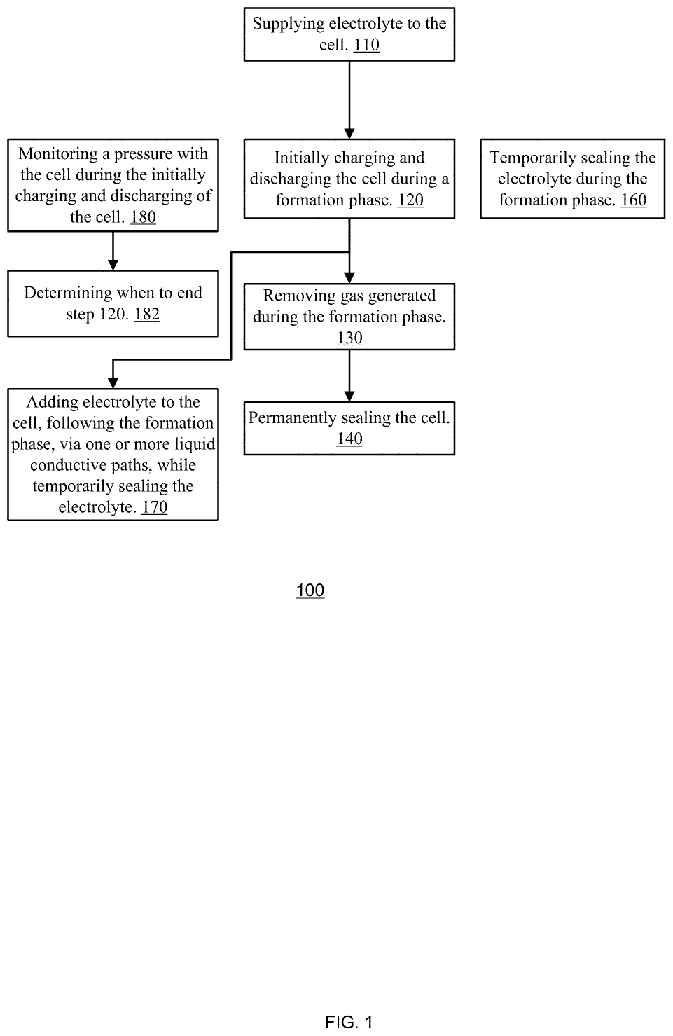

FIG. 1 illustrates an example of method 100 for managing gas generated during a formation phase of a cell that is a hard-case electrochemical cell.

Method 100 may include step 110 of supplying electrolyte to the cell.

Step 110 may be followed by step 120 of initially charging the cell during a formation phase.

Step 120 may be followed by step 130 of removing gas generated during the formation phase.

Step 130 may be followed by step 140 of permanently sealing the cell.

Method 100 may also include step 160 of temporarily sealing the electrolyte during the formation phase. The temporarily sealing may be applied only during step 160, or during one or more other steps of method 100.

Step 160 may be executed in parallel to step 120.

Step 160 may start before step 110—and in this case the electrolyte is supplied to the cell while the cell is already temporarily sealed. In this case, the electrolyte may be provided via a conduit formed in the temporal seal. The method may include a replacement of electrolyte during the formation or after formation. The method may include providing a new electrolyte, and also detract used electrolyte.

Step 160 may include mechanically and sealingly coupling a temporal cap to the cell. Thus the temporary cap is mechanically coupled to the cell in a manner that seals the cell from its environment.

When using such a temporal cap then step 120 may include initially charging and discharging of the cell by passing electrical signals via one or more conductive path (formed in the temporary cap) to one or more electrodes of the cell.

Step 120 may also be followed by step 170 of changing the amount of the electrolyte in the cell and/or replacing the electrolyte in the cell—for example adding electrolyte to the cell, following the formation phase, via one or more liquid conductive paths, while temporarily sealing the electrolyte.

Method 100 may include positioning the cell in a sealed environment before the formation phase. In this case step 160 of temporarily sealing of the electrolyte during the formation phase is executed by the sealed environment.

The sealed environment may be, for example an inner space of a chamber or a room.

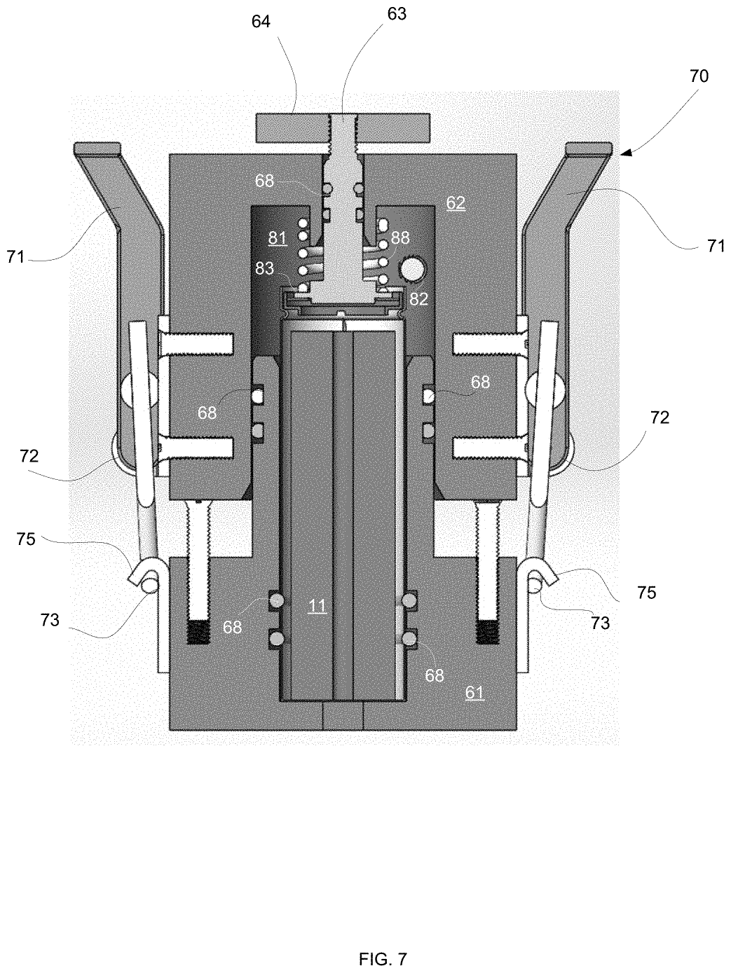

Step 160 may include mechanically and sealingly coupling a first portion the cell to a first portion of a chamber; mechanically and sealingly coupling a second portion of the cell to a second portion of the chamber; electrically coupling an electrode of the cell to a conductive path formed by the second portion of the chamber and extends outside the second portion of the chamber. The conductive path may include a spring. See, for example FIG. 7.

Step 160 may include mechanically and sealingly coupling a cap to the cell; and using (during step 140) the cap for the permanently sealing of the cell.

Method 100 may also include step 180 of monitoring a pressure with the cell during the initially charging of the cell.

Step 180 may be followed by step 182 of determining when to end step 120—based on the monitoring. For example—when reaching a certain gas level, and the like.

Step 120 may be executed after a completion of a pre-lithiation process of an anode of the cell.

It should be noted that the pressure inside the case can be described by the ideal gas equation:

P·V=n·R·T (1)

Where: P—pressure inside the case, V—available volume for the gas inside the case, n—quantity of gas (in moles), R—gas constant, T—absolute temperature (in Kelvin), For a given gas quantity, n, and constant temperature T, one can derive Boyle's Law (2) P·V=Constant

Thus, for example, if a given cell produces 20 ml of gas in atmospheric pressure (1 atm), constraining this gas amount in a 1 ml free volume inside the hard case, will raise the pressure to 20 atmospheres.

Method 100 enables to contain the gas during the formation, and release it afterwards.

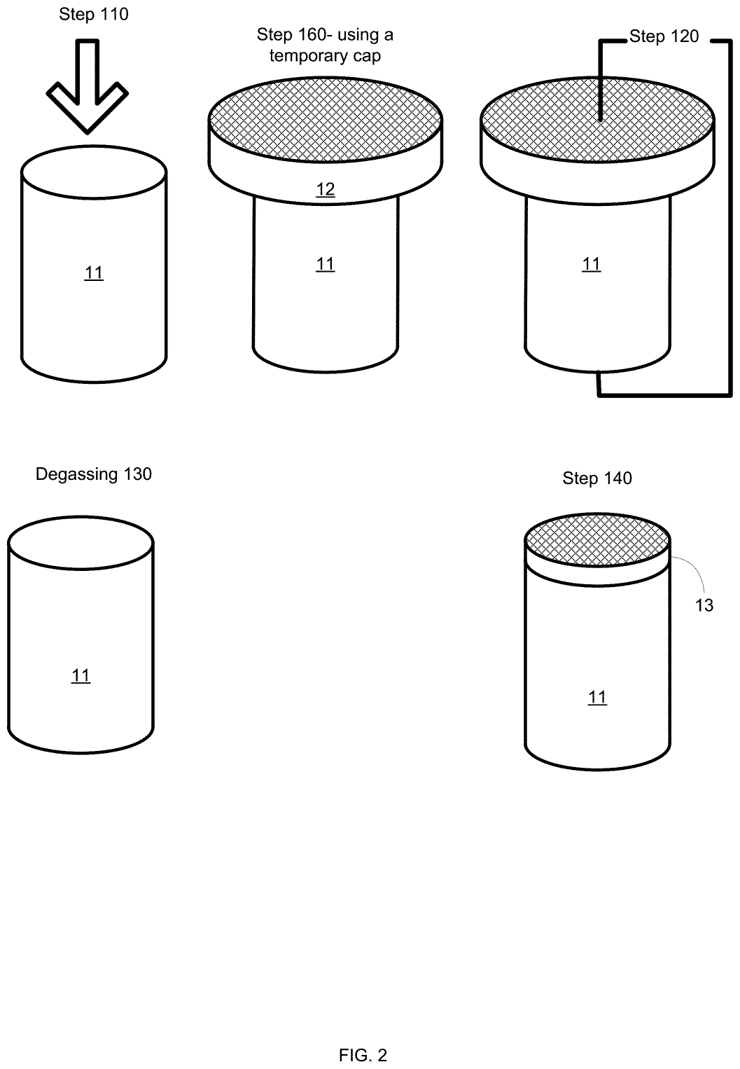

FIGS. 2-6 illustrates various examples of implementations of various step of method 100.

FIG. 2 illustrates a cell 11, a temporary cap 12, a permanent cap 13 the differs than the temporary cap (the temporary cap be bigger than the permanent cap for reducing the pressure from the gas emitted during step 120). There may be any relationship (size, shape) between the temporary cap 12 and the permanent cap 13. FIG. 2 illustrates a sequence of steps 110, 160, 120, 130 and 140. Additionally, step 120 (formation) and step 130 (degassing) can be combined together.

Temporary cap with one-way pressure release valve, when the pressure release valve can be a part of the temporary cap or a part of the permanent cap, which can be sealed after formation.

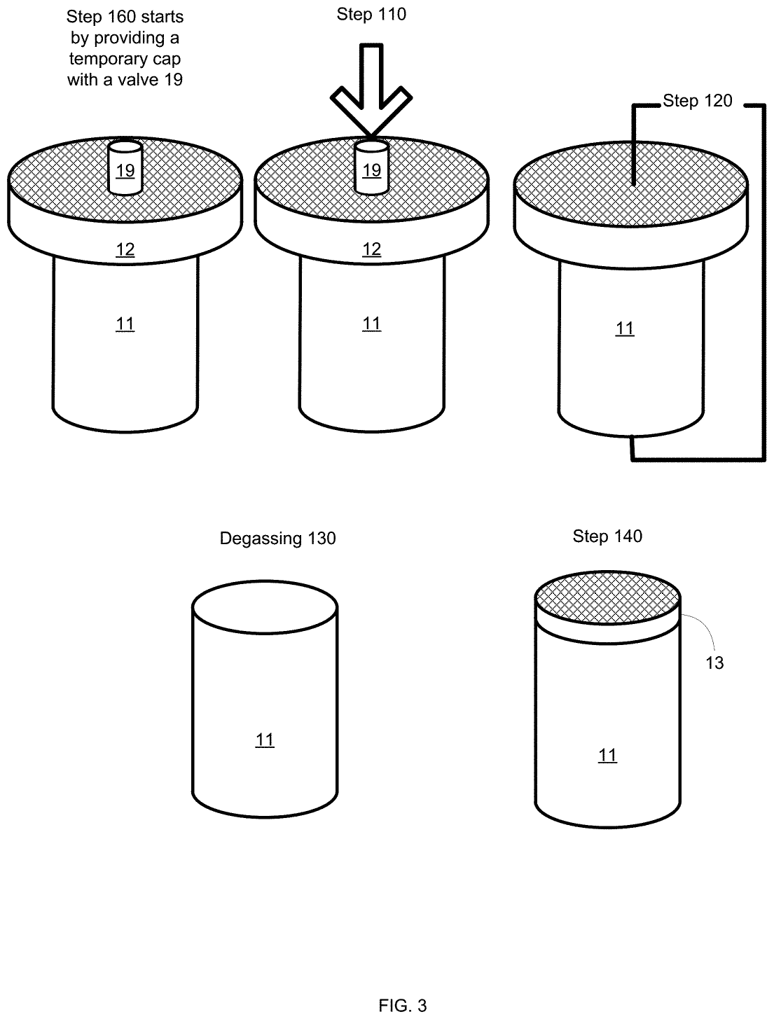

FIG. 3 illustrates a cell 11, a temporary cap 12 that has a unidirectional valve 19, and a permanent cap 13 the differs than the temporary cap. In FIGS. 3-160 starts before step 110. Step 160 may start by providing a temporary cap 12 that has a unidirectional valve 19 for providing electrolyte while maintaining the cell sealed from its environment. Step 160 is followed by step 110, that is followed by step 130 and step 140.

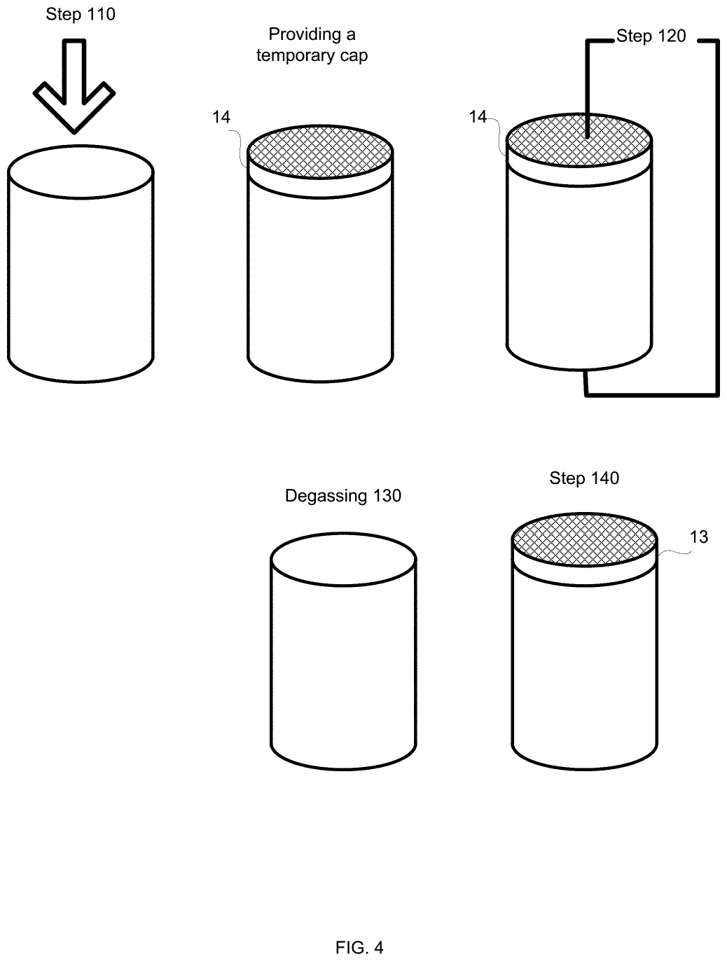

FIG. 4 illustrates a cell 11, a temporary cap 14 that is the same as the permanent cap 13. FIG. 4 illustrates a sequence of steps 110, 160, 120, 130 and 140.

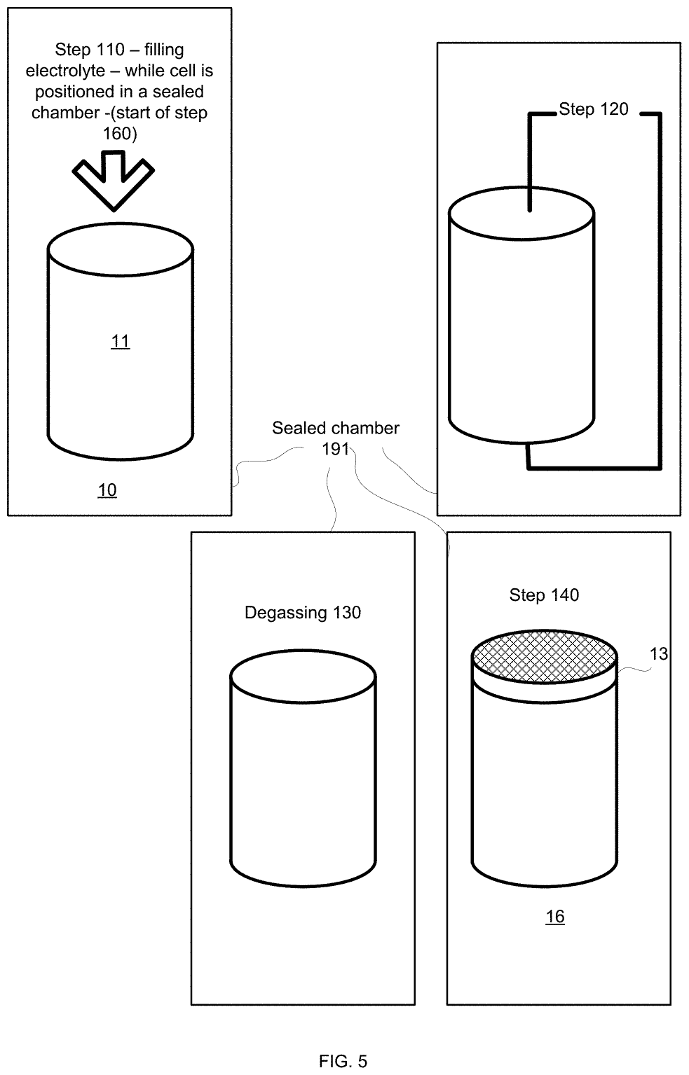

FIG. 5 illustrates a cell 11, a sealed chamber 191 that temporarily seals the cell, and a permanent cap 13. FIG. 5 illustrates steps 110, 160 (step 160 starts before step 110 or in parallel to step 110), step 120, 130 and 140.

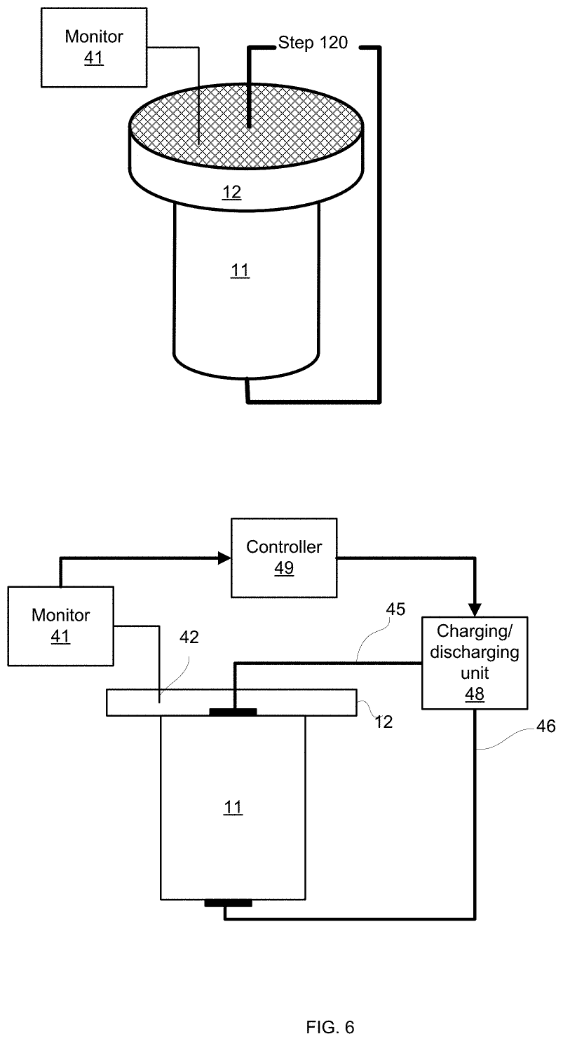

FIG. 6 illustrates an example of an implementation of step 180 of monitoring the pressure within the cell 11 by monitor 41, and also performing step 120—while a temporary cap 12 is mechanically and sealingly coupled to the cell.

The monitor 41 may communicate with or include one or more taps and/or probes and/or any other frontend element for sensing one or more parameters out of pressure, temperature, conductivity, centration, and the like. For example—tap or probe 42 that passes through the temporary cap 12 and sense one or more parameters within the temporary cap 12. A charging/discharging unit 48 may be electrically coupled to an anode and a cathode of the cell 11 and may execute step 120. A controller 49 may control step 120—for example may stop step 120 based on the pressure level within the temporary cap.

While method 100 and FIGS. 2-6 illustrated or referred a single cell—they may be applied mutatis mutandis to multiple cells located within one or more cases.

Method 100 may be executed in laboratories, in production, and the like.

FIG. 7 illustrates an example of a cell 11, a chamber, and a temporary cap.

A chamber includes a first portion 61, a second portion 62, two snap locks 70 for selectively connecting the first portion to the second portion—and holding an inner space 81 formed by the first and second portions sealed even when gas exits the cell during the formation process. Each snap lock 70 include a hook 37 that is rotatably coupled (at axis 72) to an arm of the snap lock. The hook 72 may be fastened against a holder 75 connected to the first portion 61. The first portion 61 is mechanically and sealingly coupled to a first portion (lower part) of the cell (using—for example—o-rings 68). The second portion 62 is mechanically and sealingly coupled to a second portion (upper part) of the cell (using—for example o-rings 68). An electrode of the cell 83 is electrically coupled to a conductive path 63 formed within the second portion of the chamber. FIG. 7 also illustrates an opening 82 that may be fluidly coupled to a value for degassing. The conductive path 68 extends outside the second portion of the chamber. The conductive path may include a spring. The spring 88 provides proper electrical connection by applying force. Additionally, the spring 88 may control, meaning increase or decrease, the pressure inside the cell 11 by rotating the bolt 63-64.

It should be noted that the temporary cap or the permanent cap may include a fluid (gas and/or liquid) control element (such as a valve) for inserting fluid in to the cell, during the formation and/or following the formation and the like. The cap (temporary or permanent) may include a fluid control element that may control the flow of fluid in the call and/or outside the cell.

An inserted gas may be used for various processes—for example for assisting in the formation.

The gas flow can be in atmospheric pressure, higher or lower than atmospheric pressure, or combined at different stages before, during, or after the formation.

The gas can be reactive or unreactive, soluble or insoluble in the electrolyte, and can be streamed at different temperatures.

For example: CO2 and/or CO gas can be streamed at high pressure in order to improve the formation process, and control the quality of the SEI (solid-electrolyte interphase)

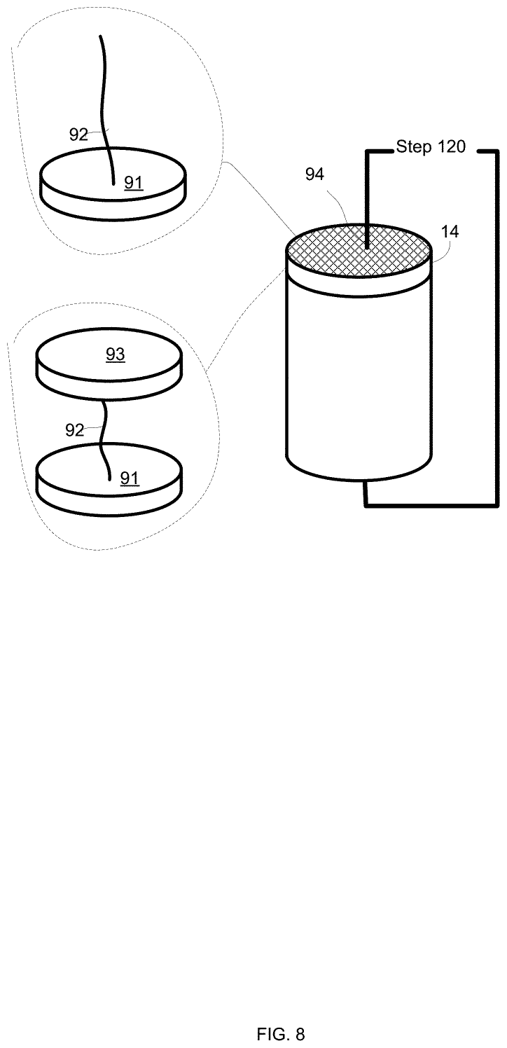

FIG. 8 illustrates two examples of a temporary cap that is connected to a connector 94 of a cycler (for performing the formation). In one example the temporary cap may include an internal connector 91 that is connected to a feed-through wire 92. In a second example—the temporary cap may include an internal connector 91 that is connected to an external connector 93 via a feed-through wire 92. The external connector 93 may be connected to the connector 94 of the cycler. The feed through wire 92 may pass through a connectors and/or through a boundary of the cell.

There may be provided a method that involves using a temporary cap may include the following steps:
a. Filling the cell with electrolyte, without sealing the cell with permanent cap.
b. Applying the temporary cap. Note, the filling may be performed after applying the temporary cap as well.
c. Formation. At this step, the temporary cap holds the built-up pressure.
d. Removing the temporary cap in proper environment (for instance, dry environment, argon, etc.).
e. Sealing with a permanent cap.

The temporary cap can serve one or more cells, and should function as:
a. Electrical connector for the formation process.
b. Include as sealing cap, that prevents evaporation of the electrolyte and/or penetration of gas (oxygen, water vapor, nitrogen or other) from the surrounding into the cell.
c. May act as a cap for the cell, as long as the permanent cap is not sealed.
d. May allow addition or detraction or replacement of electrolyte during or after the formation process—for example—may include one or more have fluid paths such as uni-directional fluid paths.

After the gas removal, there may be no need for keeping free volume in the cell that enables containing the gas is lower. Thus, the design may use more volume for components, such as electrodes and/or electrolyte, so that the capacity of the cell can be higher for a given case volume.

The temporary sealing may be provided by a sealed environment (such as but not limited to room, chamber etc.) where the sealed environment serves as a temporary cap and has current collector for the cell or cells for charging and/or formation.

The temporary cap can serve one or more hard-cased cells. For example only: Cap for a single 21700 cell, Cap for a single prismatic cell, Cap for a single 4680 cell. Cap for multiple 21700 cells.

Two experiments have proven the necessity of the temporary cap for 21700 cells with high content metalloids as anode active material, which produce more gas during formation than standard graphite anode.

The first experiment comprised of a metalloid anode in a 21700 cell. In this cell, a standard procedure was conducted, and no temporary cap was in use.

In this experiment, the CID was broken due to an increase in the internal pressure. It can be seen that after formation, the CID is bulging upwards, which is a sign of its breakage due to the internal pressure.

The second experiment comprised of a metalloid anode in a 21700 cell. In this cell, a temporary cap was placed onto the cell. The formation process has been completed successfully. The pressure in the end of the formation process was 1.5 atm. The configuration is as in FIG. 2. The free volume in the temporary cap was 22.5 ml, which is about 18 times more than if a standard process was conducted. Thus, we can conclude, that if a temporary cap hasn't been used, the pressure would have increased to 27 atmospheres instead of 1.5 atmospheres (P=1.5 atm×22.5 ml/1.25 ml), that would have broken the CID. Hence, the temporary cap is necessary for this process and chemistry.

The formation process has been completed successfully

Summary Table of experiment—Lithium ion cell with high metalloid content anode underwent the following procedures:

| | Temp cap | Degassing | Formation | | |
|---|---|---|---|---|---|
| Case type | (Y/N) | (Y/N) | process | Cycling | Comments |
| Soft pack: | N | Y | pass | Pass-Cycled to | Reference (standard |
| Pouch (shaped | | | | end of life | degassing after |
| laminate)- | | | | | formation) |
| prior art | | | | | |
| Hard case: | N | N | Fail due to | N/A | High pressure in |
| A21700 | | | mechanical | | cylindrical case caused |
| cylindrical | | | failure | | a breakage of CID |
| cell-prior art | | | | | |
| Hard case: | Y | Y | pass | Pass-Cycled to | |
| A21700 | | | | end of life | |
| cylindrical | | | | | |
| cell-according | | | | | |
| to an example | | | | | |
| of the application | | | | | |

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for managing gas generated during a formation phase of a cell that is a hard-case electrochemical cell, the method comprises:
supplying electrolyte to the cell;
initially charging and discharging the cell during a formation phase; and
permanently sealing the cell;
wherein the method further comprises temporarily sealing the electrolyte during the formation phase.

2. The method according to claim 1 wherein the method comprises ending the temporarily sealing, and releasing the gas from the cell before the permanently sealing of the cell.

3. The method according to claim 1 wherein the temporarily sealing comprises mechanically and sealingly coupling a temporal cap to the cell.

4. The method according to claim 3 wherein the initially charging of the cell comprises passing electrical signals via one or more conductive path to one or more electrodes of the cell.

5. The method according to claim 1 comprising changing an amount of at least one out of an electrolyte, salt, solvent and one or more electrolyte additives of the cell, following the formation phase, via one or more liquid conductive paths, while temporarily sealing the electrolyte.

6. The method according to claim 1 comprising replacing at least one out of an electrolyte, salt, solvent and one or more electrolyte additives of the cell, following the formation phase, via one or more liquid conductive paths, while temporarily sealing the electrolyte.

7. The method according to claim 1 comprising positioning the cell in a sealed environment before the formation phase; and wherein the temporarily sealing of the electrolyte during the formation phase is executed by the sealed environment.

8. The method according to claim 7 wherein the sealed environment is an inner space of a chamber or a room.

9. The method according to claim 1 comprising mechanically and sealingly coupling a first portion the cell to a first portion of a chamber; mechanically and sealingly coupling a second portion of the cell to a second portion of the chamber; electrically coupling an electrode of the cell to a conductive path formed by the second portion of the chamber and extends outside the second portion of the chamber.

10. The method according to claim 9 wherein the conductive path comprises a spring.

11. The method according to claim 1 wherein the temporarily sealing comprises mechanically and sealingly coupling a cap to the cell; and using the cap for the permanently sealing of the cell.

12. The method according to claim 1 comprising monitoring a pressure with the cell during the initially charging and discharging of the cell.

13. The method according to claim 11 comprising determining when to end the initially charging and discharging of the cell based on the monitoring.

14. The method according to claim 1 wherein the forming process is executed after a completion of a pre-lithiation process of an anode of the cell.

15. The method according to claim 1 wherein the permanently sealing the cell comprises permanently sealing the cell with a permanent cap with a gas release valve.

16. The method according to claim 1 comprising inserting fluid to the cell via a fluid control element.

17. A hard-case electrochemical cell that comprises a hard case, electrolyte, an anode, wherein the hard-case electrochemical cell is manufactured by a manufacturing process that comprises supplying the electrolyte to the cell; initially charging the cell during a formation phase; and permanently sealing the cell; wherein the manufacturing method further comprises temporarily sealing the electrolyte during the formation phase.

18. A method for operating a hard-case electrochemical cell, the method comprises charging and discharging the hard-case electrochemical cell; wherein the hard-case electrochemical cell comprises a hard case, electrolyte, an anode, wherein the hard-case electrochemical cell is manufactured by a manufacturing process that comprises supplying the electrolyte to the cell; initially charging and discharging the cell during a formation phase; and permanently sealing the cell;
wherein the manufacturing method further comprises temporarily sealing the electrolyte during the formation phase.

19. A hard-case electrochemical cell that comprises a permanent seal, a hard case, electrolyte, an anode, and one or more fluid control element for controlling a flow of fluid to the cell or out of the cell.
